(19) United States
(12) Patent Application Publication
(10) Pub. No.: US 2021/0074498 A1
(43) Pub. Date: Mar. 11, 2021

(54) MUTUALLY EXCLUSIVE POWER CONTROLLER WITH MASTER LOCKOUT

(71) Applicant: Communitronics Corp., Fenton, MO (US)

(72) Inventor: Michael A. Leitensdorfer, High Ridge, MO (US)

(21) Appl. No.: 17/013,002

(22) Filed: Sep. 4, 2020

Related U.S. Application Data
(60) Provisional application No. 62/896,711, filed on Sep. 6, 2019.

(51) Int. Cl. H01H 47/00; H01H 47/22; H01R 13/70; H01R 25/00

(52) U.S. Cl. CPC H01H 47/001; H01H 47/22; H01R 2103/00; H01R 25/00; H01R 13/70

(57) ABSTRACT

A mutually exclusive power controller with master lockout. The controller includes a plurality of isolated power circuits electrically connected to an AC power supply. Each of the isolated power circuits has a female receptacle for mating engagement with a corresponding male plug and a relay electrically connected to the receptacle. The relay connects the receptacle to the AC power supply when the relay is energized. A master lockout electrically connected between the AC power supply and the relay of each of the isolated power circuits disconnects the isolated power circuits from the AC power supply when the master lockout is at rest.

### CROSS-REFERENCE TO RELATED APPLICATION

The present application claims the benefit of U.S. Provisional Application No. 62/896,711, filed Sep. 6, 2019, the entire disclosure of which is incorporated herein by reference.

### BACKGROUND

Aspects of the present disclosure relate to power controllers.

Conventional programmable/configurable power strips can be altered via programming and/or wiring to allow more than one classification of circuit (e.g., secure, non-secure, top secret, sensitive compartmented information, etc.) to be energized at a time. This means if a Secure Videoconference is in process and a Non-Secure Videoconference Codec was to receive power simultaneously, the possibility of a security data breach via the non-secure channel is unacceptably high. This conditional state could allow SECURE information that was spoken verbally, seen visually, or transmitted electronically to be accessed by person(s) in a NON-SECURE environment.

A power controller that cannot be overridden such as with conventional power controllers that have contact closure, IP, or serial control is desired.

### SUMMARY

A mutually exclusive power controller with master lockout embodying aspects of the present disclosure can be utilized with a variety of external dry contact switches or control devices that provide a dry contact closure for an intrinsically safe low voltage method of insuring that only one chosen system is activated at any given time. The ability to safely control AC power to secure systems without directly accessing equipment eliminates the potential for accidental or unauthorized activation. Hierarchy of control prevents activation of higher priority systems when a lower priority system is active. The master lockout feature disables all systems to prevent unauthorized activation.

In an aspect, a mutually exclusive power controller with master lockout includes a plurality of isolated power circuits electrically connected to an AC power supply. Each of the isolated power circuits has a female receptacle for mating engagement with a corresponding male plug and a relay electrically connected to the receptacle. The relay connects the receptacle to the AC power supply when the relay is energized. A master lockout electrically connected between the AC power supply and the relay of each of the isolated power circuits disconnects the isolated power circuits from the AC power supply when the master lockout is at rest.

In another aspect, a mutually exclusive power controller comprises a plurality of isolated power circuits configured to be electrically connected to an AC power supply. The isolated power circuits are electrically connected to each other in a hierarchy configured to prevent activation of a higher priority isolated power circuit when a lower priority isolated power circuit is active. Each of the isolated power circuits has a female receptacle configured for mating engagement with a corresponding male plug and a single pole double throw relay electrically connected to the receptacle. The relay is configured to connect the receptacle to the AC power supply when the relay is energized. The power controller also includes a single pole single throw master lockout electrically connected between the AC power supply and the isolated power circuits. The master lockout is configured to disconnect the isolated power circuits from the AC power supply such that the relay of each of the isolated power circuits is not energized when the master lockout is at rest. By energizing the relay of the higher priority isolated power circuit, the relay of the lower priority isolated power circuit is prevented from being energized.

Other objects and features will be in part apparent and in part pointed out hereinafter.

### BRIEF DESCRIPTION OF THE DRAWINGS

FIG. 1 is a schematic diagram of a four channel mutually exclusive power controller with master lockout in accordance with an embodiment.

FIG. 2 is a rear view of the power controller having a terminal block connector plug for each channel and the master lockout in accordance with an embodiment.

FIGS. 3A-3D lockout configurations in accordance with an embodiment.

Corresponding reference characters indicate corresponding parts throughout the drawings.

### DETAILED DESCRIPTION

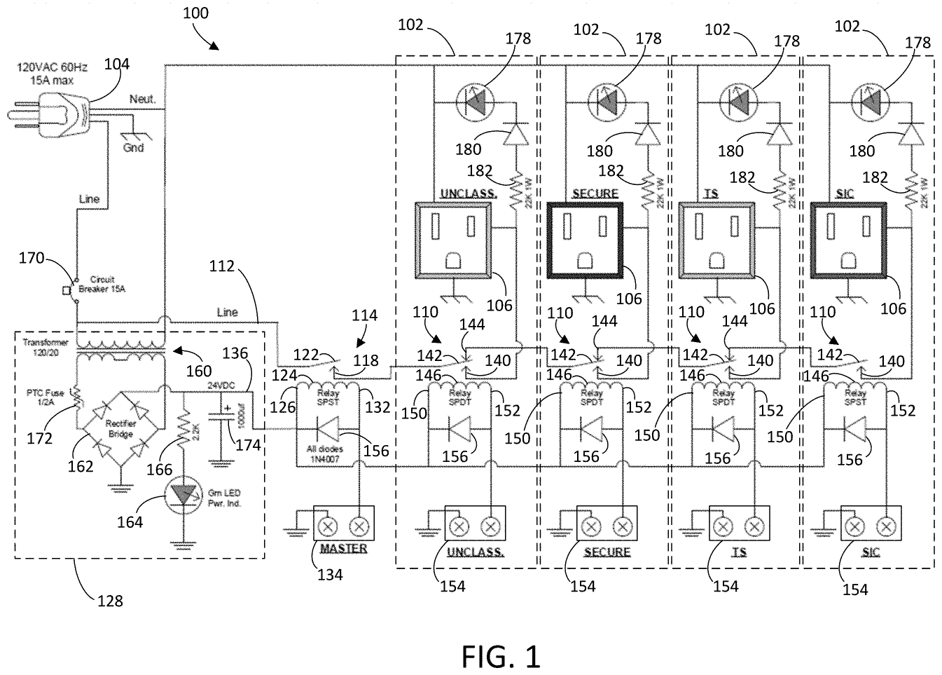

A mutually exclusive, multi-channel power controller 100 with master lockout embodying aspects of the present disclosure can be utilized with a variety of external dry contact switches or control devices that provide a dry contact closure for an intrinsically safe low voltage method of insuring that only one chosen system is activated at any given time. The ability to safely control AC power to secure systems without directly accessing equipment eliminates the potential for accidental or unauthorized activation. FIG. 1 illustrates a circuit embodying aspects of the power controller 100 having a master lockout in accordance with the present disclosure. The various components of the power controller 100 are described below.

The mutually exclusive power controller 100 of FIG. 1 comprises a plurality of isolated power circuits 102 configured to be electrically connected to an AC power supply via a plug 104. For example, the plug 104 comprises a 14 AWG power cord cable having a 15 Amp rating and three conductors (NEMA 5-15P to IEC-320-C13). Each of the isolated power circuits 102 comprises a female receptacle 106 configured for mating engagement with a corresponding male plug of an external device. In an embodiment, each female receptacle 106 is an industrial heavy duty grade 120 Volt, 15 Amp single receptacle having a straight blade with ground.

Each power circuit 102 also includes a relay 110 electrically connected to the receptacle 106. The relay 110 is configured to connect receptacle 106 to the AC power supply via line 112 when relay 110 is energized. The power controller also includes a master lockout 114 electrically connected between the AC power supply and relay 110 of each of the isolated power circuits 102 via the line 112. According to aspects of the present disclosure, the master lockout 114 is configured to disconnect the isolated power circuits 102 from the AC power supply when master lockout 114 is at rest.

As shown in FIG. 1, master lockout 114 according to an embodiment is a single pole single throw relay having a normally open terminal 118, a common terminal 122, and a master lockout coil 124. The coil 124 has a first end 126 electrically connected to a DC power supply 128. The coil 124 has a second end 132 electrically connected to a corresponding master lockout terminal connector 134. The master lockout coil 124 is configured to be energized by the DC power supply 128 via line 136 for closing the normally open terminal 118 when coil 124 is connected to ground via the corresponding master lockout terminal connector 134. When coil 124 of master lockout relay 114 is at rest (not energized), common terminal 122 and normally open terminal 118 have no continuity.

The relay 110 of FIG. 1 comprises a single pole double throw relay having a normally open terminal 138, a common terminal 142, a normally closed terminal 144, and a relay coil 146. In the illustrated embodiment, the coil 146 has a first end 150 electrically connected to DC power supply 128 and a second end 152 electrically connected to a corresponding relay terminal connector 154. The coil 146 is configured to be energized by DC power supply 128 via line 136 for closing the normally open relay terminal 138 when coil 146 is connected to ground via the corresponding relay terminal connector 154. The female receptacle 106 is connected to the AC power supply via line 112 when relay coil 146 and master lockout coil 124 are both are energized.

As shown in FIG. 1, the normally closed terminal 144 of relay 110 is electrically connected to normally open master lockout terminal 118 via the common relay terminal 142 such that the isolated power circuits 102 are electrically connected in series to the AC power supply via master lockout 114. When coil 146 of relay 110 is at rest (not energized), common terminal 142 and normally closed terminal 144 have continuity.

In an embodiment, master lockout 114 and each relay 110 employs a flyback diode 156. Because an inductor (i.e., coil 124 or coil 146) cannot change its current instantly, the flyback diode 156 provides a path for the current when the corresponding coil 124, 146 is switched off. Advantageously, flyback diode 156 prevents a voltage spike that could cause arcing on switch contacts.

Referring further to FIG. 1, DC power supply 128 comprises a 120 Volt AC step down transformer 160 and a full wave bridge rectifier 162. The transformer 160 is electrically connected to the AC power supply via plug 104 and the rectifier 162 makes use of both half cycles of input alternating current (AC) and converts them to direct current (DC). In the illustrated embodiment, a green LED 164, electrically connected to line 136 via a 2.2k Ohm 1 Watt current limiting resistor 166, indicates when line 136 has power.

For safety, power controller 100 includes a 120 Volt 15-Amp circuit breaker 170 with reset in line 112 and a polymeric positive temperature coefficient (PPTC) ½ Amp fuse 172 following step down transformer 160. The PPTC fuse 172 is a passive electronic component used to protect against overcurrent faults in electronic circuits. In an embodiment, power controller 100 also includes a 1000 μF capacitor 174 between line 136 and ground that forms a low-pass filter for line 136, as it removes high-frequency signals from the line by giving those signals a low-impedance path to ground.

Each power circuit 102 also includes an active circuit power indication green LED 178 for indicating when the corresponding receptacle 106 has power via line 112 and the respective relay 110. In an embodiment, a protection diode 180 in series with a 22 kOhm 1 Watt current limiting resistor 182 prevents reverse current flow in the circuit.

In operation, the mutually exclusive power controller 100 with master lockout ensures electrical isolation between all videoconferencing codecs in a multi classification, multi codec videoconference system. The failsafe design of power controller 100 ensures that only one 120 Volt AC circuit can be energized at any time. This guarantees that only one codec classification can have electrical power at any time. The only certain way to guarantee data integrity and that there is no data leakage is to electrically disconnect power to a device. The power controller 100 cannot be overridden such as with conventional programmable/configurable power controllers that have contact closure, IP, or serial control. The conventional types of power strips can be altered via programming and/or wiring to allow more than one classification of circuit to be energized at a time. This means if a Secure Videoconference is in process and the Non-Secure Videoconference Codec was to receive power simultaneously the possibility of a security data breach is unacceptably high via the non-secure channel. This conditional state could allow SECURE information that was spoken verbally, seen visually, or transmitted electronically to be accessed by person(s) in a NON-SECURE environment. Advantageously, power controller 100 ensures the Non-Secure Videoconference Codec cannot receive power during a Secure Videoconference.

The Defense Information Systems Agency (DISA)/Continental United States (CON US) preferred design of a multi videoconferencing codec system differs from a single codec solution that must traverse different classifications of networks. Every time the single codec solution is to power on the codec it must be reconfigured for the classification of the network it is to communicate on. This process of reconfiguration takes a considerable amount of time as it can only happen after the codec has had time to complete its boot sequence, then be reconfigured, and then be re-booted again all of this adversely affects the videoconferencing time necessary to place a call. A multi codec solution time to place a call is dependent on the time for a given codec to power on. Subsequent changes in classification are only dependent on the next codec powering on as the codec can store its network information since it is dedicated to a single network and not the same codec going through the deletion of data, re-boot, re-configuration of the codec and other re-boot, before the codec is ready to place the call.

The power controller 100 embodying aspects of the present disclosure is controllable by third party controllers via dry contact closure, does not require a yearly service fee or any type of software updates, and is totally agnostic as to the codec it is connected to (unlike a single codec solution). In addition, power controller 100 is not affected by differences in software version and does not require system commissioning fees as with a single codec solution. The design of a multi codec videoconferencing system greatly reduces the number of applicable Security Technical Implementation Guide (STIG) requirements of a single codec solution. Any STIG requirement that includes the term “Periods Processing” is not applicable in a multiple codec video teleconference solution.

In an embodiment, power controller 100 can be utilized with a variety of external dry contact switches or control devices that provide a dry contact closure for an intrinsically safe low voltage method of insuring that only one chosen system is activated at any given time. The ability to safely control AC power to secure systems without directly accessing equipment eliminates the potential for accidental or unauthorized activation. Hierarchy of control prevents activation of higher priority systems when a lower priority system is active. The master Lockout feature disables all systems to prevent unauthorized activation. Universal mounting brackets are included.

In an embodiment, the power control has the following construction and features: Compact steel chassis with black powder epoxy finish; Power Rating of 15A 125VAC; Four Independent NEMA 5-15R Single Receptacles; Color coded terminals and receptacles for clear, intuitive operation; Detachable 6-ft. cord with NEMA 5-15P plug; Dimensions (H×W×D) of 1.500″×12.000″×6.000″; and Control Type—Dry Contact.

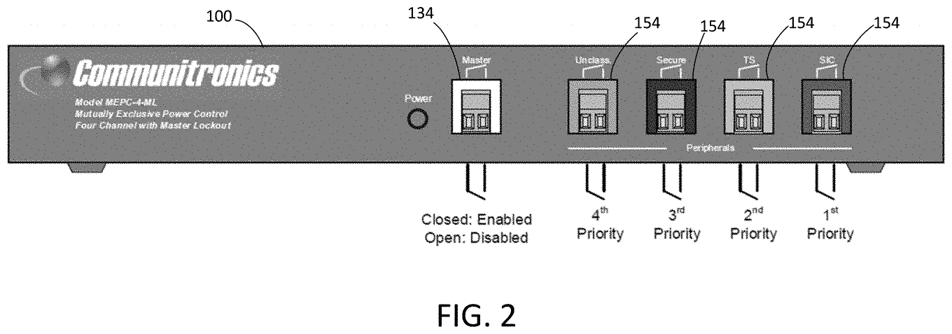

FIG. 2 is a rear view of a housing containing power controller 100. In accordance with an embodiment, power controller 100 has a terminal block connector plug 154 for each channel (i.e., isolated power circuit 102) and a terminal block connector plug 134 for master lockout 114. As described above, hierarchy of control prevents activation of higher priority systems when a lower priority system is active. The master lockout feature disables all systems to prevent unauthorized activation. FIG. 2 illustrates four channels of power circuits 102. The four channels in the illustrated embodiment are labeled SIC, TS, Secure, and Unclassified and are prioritized first through fourth, respectively. For example, the first (SIC), second (TS), and third (Secure) priority channels cannot be active when the fourth (Unclassified) priority channel is active because energizing the relay 110 of the isolated power circuit 102 corresponding to the Unclassified channel disconnects the remaining relays 110 from line 112. In this embodiment, the SIC channel corresponds to a first isolated power circuit 102, the TS channel corresponds to a second isolated power circuit 102, the Secure channel corresponds to a third isolated power circuit 102, and the Unclassified channel corresponds to a fourth isolated power circuit 102.

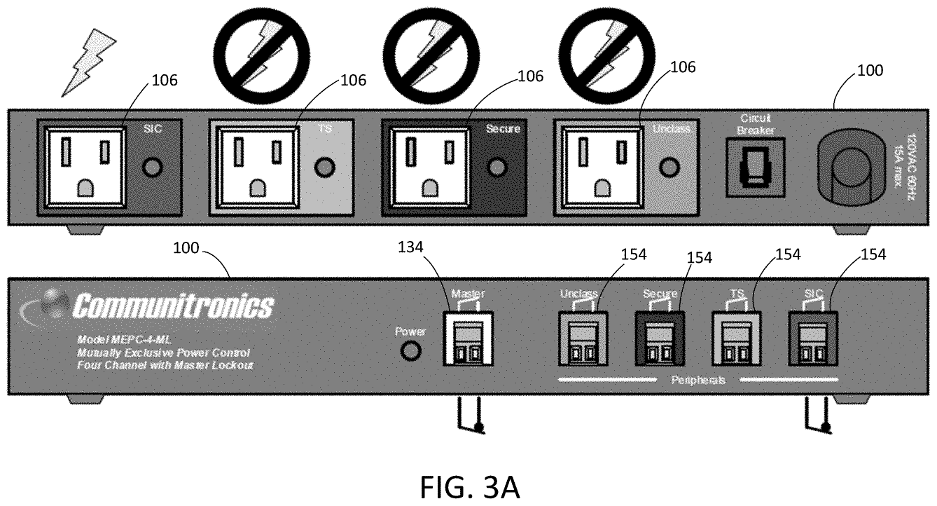

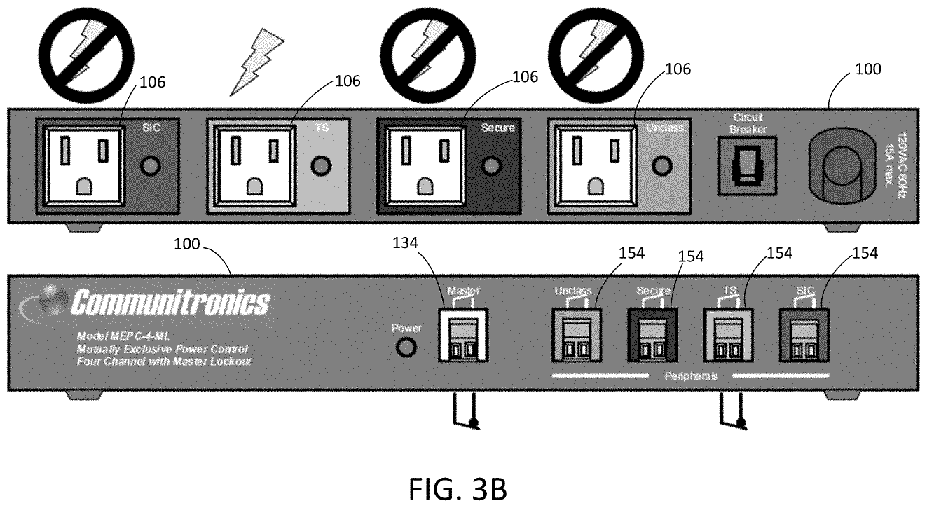

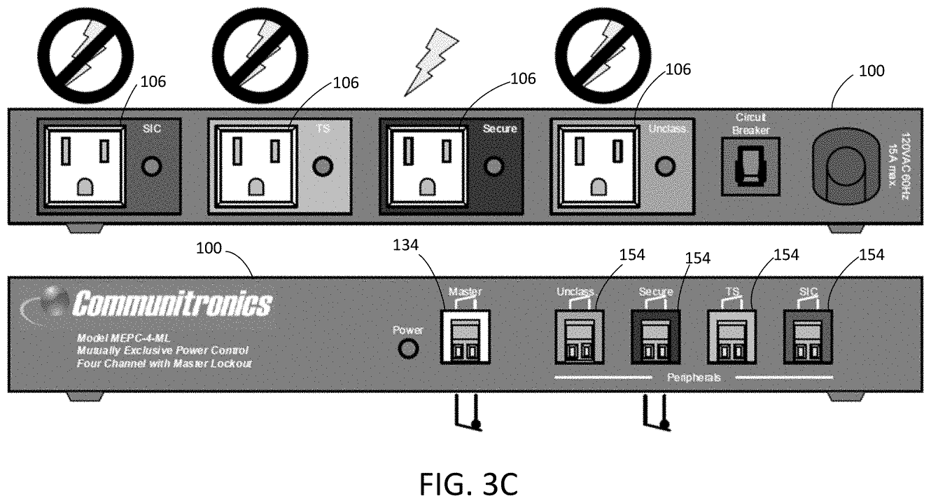

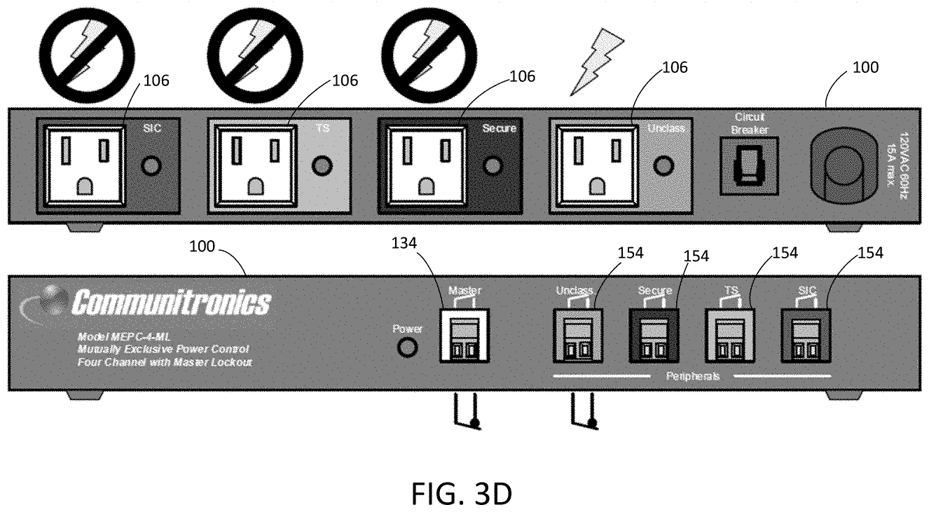

FIGS. 3A-3D lockout configurations in accordance with an embodiment. In each of FIGS. 3A-3D, the master lockout 114 is energized, as indicated by the closed terminal connector 134. Thus, enabling the power circuits 102 by the corresponding terminal connector 154 determines which channel is active. As shown, different classifications cannot be energized at the same time, which makes the non-hackable, non-programmable, secure power controller 100 particularly well-suited for use in mixed level secure videoconferencing environments.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A mutually exclusive power controller comprising:
a plurality of isolated power circuits configured to be electrically connected to an AC power supply, each of the isolated power circuits comprising:
a female receptacle configured for mating engagement with a corresponding male plug; and
a relay electrically connected to the receptacle, the relay configured to connect the receptacle to the AC power supply when the relay is energized; and
a master lockout electrically connected between the AC power supply and the relay of each of the isolated power circuits, the master lockout configured to disconnect the isolated power circuits from the AC power supply when the master lockout is at rest.

2. The power controller set forth in claim 1, wherein the master lockout comprises a normally open master lockout terminal and a master lockout coil, the master lockout coil having an end electrically connected to a DC power supply and another end electrically connected to a corresponding master lockout terminal connector, the master lockout coil configured to be energized by the DC power supply for closing the normally open master lockout terminal when the master lockout coil is connected to ground via the corresponding master lockout terminal connector.

3. The power controller set forth in claim 2, further comprising a flyback diode electrically connected in parallel with the master lockout coil.

4. The power controller set forth in claim 2, wherein the relay comprises a normally open relay terminal and a relay coil, the relay coil having an end electrically connected to the DC power supply and another end electrically connected to a corresponding relay terminal connector, the relay coil configured to be energized by the DC power supply for closing the normally open relay terminal when the relay coil is connected to ground via the corresponding relay terminal connector, and wherein the female receptacle is connected to the AC power supply when the relay coil and the master lockout coil are energized.

5. The power controller set forth in claim 4, further comprising a flyback diode electrically connected in parallel with the relay coil.

6. The power controller set forth in claim 4, wherein the relay further comprises a normally closed relay terminal and a common relay terminal, the normally closed relay terminal electrically connected to the normally open master lockout terminal via the common relay terminal such that the isolated power circuits are electrically connected in series to the AC power supply via the master lockout.

7. The power controller set forth in claim 6, wherein the normally open master lockout terminal is electrically connected to the common relay terminal of one of the isolated power circuits and the normally closed relay terminal of the one of the isolated power circuits is electrically connected to the common relay terminal of another one of the isolated power circuits.

8. The power controller set forth in claim 6, wherein the plurality of isolated power circuits comprises at least a first isolated power circuit and a second isolated power circuit, and wherein the normally closed relay terminal of the second isolated power circuit is electrically connected to the common relay terminal of the first isolated power circuit.

9. The power controller set forth in claim 8, wherein the normally open master lockout terminal is electrically connected to the common relay terminal of the second isolated power circuit.

10. The power controller set forth in claim 8, wherein the plurality of isolated power circuits comprises at least a third isolated power circuit, and wherein the normally closed relay terminal of the third isolated power circuit is electrically connected to the common relay terminal of the second isolated power circuit.

11. The power controller set forth in claim 10, wherein the normally open master lockout terminal is electrically connected to the common relay terminal of the third isolated power circuit.

12. The power controller set forth in claim 10, wherein the plurality of isolated power circuits comprises at least a fourth isolated power circuit, and wherein the normally closed relay terminal of the fourth isolated power circuit is electrically connected to the common relay terminal of the third isolated power circuit.

13. The power controller set forth in claim 12, wherein the normally open master lockout terminal is electrically connected to the common relay terminal of the fourth isolated power circuit.

14. The power controller set forth in claim 1, wherein the isolated power circuits are electrically connected to each other in a hierarchy configured to prevent activation of a higher priority isolated power circuit when a lower priority isolated power circuit is active.

15. A mutually exclusive power controller comprising:
a plurality of isolated power circuits configured to be electrically connected to an AC power supply, the isolated power circuits electrically connected to each other in a hierarchy configured to prevent activation of a higher priority isolated power circuit when a lower priority isolated power circuit is active, the isolated power circuits each comprising:
a female receptacle configured for mating engagement with a corresponding male plug; and
a single pole double throw relay electrically connected to the receptacle, the relay configured to connect the receptacle to the AC power supply when the relay is energized; and
a single pole single throw master lockout electrically connected between the AC power supply and the isolated power circuits, the master lockout configured to disconnect the isolated power circuits from the AC power supply such that the relay of each of the isolated power circuits is not energized when the master lockout is at rest,
wherein energizing the relay of the higher priority isolated power circuit prevents the relay of the lower priority isolated power circuit from being energized.

16. The power controller set forth in claim 15, wherein:
the master lockout comprises a normally open master lockout terminal and a master lockout coil, the master lockout coil electrically connected between a DC power supply and a corresponding master lockout terminal connector, the master lockout coil configured to be energized by the DC power supply for closing the normally open master lockout terminal when the master lockout coil is connected to ground via the corresponding master lockout terminal connector, and
the relay of each isolated power circuit comprises a normally open relay terminal and a relay coil, the relay coil electrically connected between the DC power supply and a corresponding relay terminal connector, the relay coil configured to be energized by the DC power supply for closing the normally open relay terminal when the relay coil is connected to ground via the corresponding relay terminal connector, and
the female receptacle of one of the isolated power circuits is connected to the AC power supply when the relay coil of the one of the isolated power circuits and the master lockout coil are both energized.

17. The power controller set forth in claim 15, wherein the plurality of isolated power circuits comprises at least a first isolated power circuit and a second isolated power circuit, and wherein a normally closed terminal of the relay of the second isolated power circuit is electrically connected to a common terminal of the first isolated power circuit.

18. The power controller set forth in claim 17, wherein the normally closed terminal of the relay of the second isolated power circuit is electrically connected to a normally open terminal of the master lockout via a common terminal of the relay of the second isolated power circuit such that the second isolated power circuit is electrically connected in series to the AC power supply via the master lockout when the master lockout and the relay of the second isolated power circuit are energized and the normally open terminal of the master lockout and a normally open terminal of the relay of the second isolated power circuit are closed.

19. The power controller set forth in claim 18, wherein the relay of the first isolated power circuit is electrically disconnected from the AC power supply when the normally open terminal of the relay of the second isolated power circuit is closed and the second isolated power circuit is electrically connected in series to the AC power supply via the master lockout.

20. The power controller set forth in claim 17, wherein a normally closed terminal of the relay of the first isolated power circuit is electrically connected to a normally open terminal of the master lockout via the common terminal of the relay of the first isolated power circuit and the normally closed terminal of the relay of the second isolated power circuit such that the first isolated power circuit is electrically connected in series to the AC power supply via the master lockout and the relay of the second isolated power circuit when the master lockout and the relay of the first isolated power circuit are energized and the normally open terminal of the master lockout and a normally open terminal of the relay of the first isolated power circuit are closed.
